(19) United States
(12) Patent Application Publication
(10) Pub. No.: US 2003/0197689 A1
(43) Pub. Date: Oct. 23, 2003

(54) Input device that allows multiple touch key input

(76) Inventor: Gregory J. May, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 10/128,679

(22) Filed: Apr. 23, 2002

(51) Int. Cl. G09G 5/00

(52) U.S. Cl. 345/173

(57) ABSTRACT

Multiple touch entries on an input device are recognized. Upon a user selecting a first key, the first key is recognized based on first detected values. The first detected values are mapped to the first key based on a first mapping of detected values to keys. When the first key supports at least one secondary key, upon a user selecting a second key while continuing to select the first key, the second key is recognized based on second detected values. The second detected values are mapped to the second key based on a second mapping of detected values to keys. The second mapping of detected values to keys is different than the first mapping of detected values to keys.

### BACKGROUND OF THE INVENTION

The present invention relates to input devices for computing systems and relates particularly to an input device that allows multiple touch key input.

Keyboards used for data input to systems such as computers and terminal devices typically use scanned context switches arranged in a matrix. This arrangement allows use of multiple touch entries. Multiple touch entries are entries that require multiple key selections. For example, to enter a capital letter, a typist generally selects and holds a “shift” key and a letter. Likewise, special characters or function shortcuts are often entered by selecting and holding one or more shift, control, option or other special keys followed by the selection of another key.

In order to reduce manufacturing costs or allow pen input entries, some keyboards are implemented as touch pads. Low cost touch pads used for track pads for computers or touch screens are typically constructed with two sheets of conductive coated material layered on top of each other with conductive sides facing each other. Often these conductive layers are constructed with Indium Tin Oxide (ITO) in a thin layer such that it can be transparent and used over LCD screens. Other products where transparent characteristics are not needed, use carbon or some other conductive material coated on a Mylar type substrate. Spacing between the layers is accomplished with small spacers, often in the form of glass beads, that hold the layers apart.

Each layer is tied to two conductors that are strobed or biased to generate a voltage gradient, one layer along the horizontal dimension and one layer along the vertical dimension. In effect this is a larger resistor strung between two conducting points. Each layer is placed 90 degrees opposed from each other and strobed out of phase from each other. By tapping into the resistor string (formed by the conductive/resistive material), a voltage is sampled that relates to the position of the tap point. By alternating the strobe between the layers and the axis, it is possible to determine the position of the contact point (with enough pressure to have the two layers touch each other) in each dimension—X for the first strobe and Y for the alternating strobe, for example. For the layer that is not being strobed, the contact points are not biased and act as a high impedance probes sample the voltage on the unstrobed layer.

In the prior art, low cost touch pads and touch screens constructed with two sheets of conductive coated material have the disadvantage that they cannot recognize more than one distinct input/touch to the pad. This makes them an inefficient input device for typists who are used to selecting and holding shift, control, option or other special keys during multiple touch entries.

### SUMMARY OF THE INVENTION

In accordance with an embodiment of the present invention, multiple touch entries on an input device are recognized. Upon a user selecting a first key, the first key is recognized based on first detected values. The first detected values are mapped to the first key based on a first mapping of detected values to keys. When the first key supports at least one secondary key, upon a user selecting a second key while continuing to select the first key, the second key is recognized based on second detected values. The second detected values are mapped to the second key based on a second mapping of detected values to keys. The second mapping of detected values to keys is different than the first mapping of detected values to keys.

### BRIEF DESCRIPTION OF THE DRAWINGS

FIG. 1 is a simplified schematic of an input device illustrating detection of a point of touch in a horizontal direction.

FIG. 2 is a simplified schematic of the input device shown in FIG. 1 illustrating detection of a point of touch in a vertical direction.

FIG. 3 shows the relationship of voltage bias across the horizontal plane and voltage bias across the vertical plane for the input device shown in FIG. 1.

FIG. 4 is a simplified flowchart describing multiple touch key detection in accordance with an embodiment of the present invention.

FIG. 5 is a simplified schematic illustrating multiple touch detection in a horizontal direction in accordance with an embodiment of the present invention.

FIG. 6 is a simplified schematic illustrating multiple touch detection in a vertical direction in accordance with an embodiment of the present invention.

FIG. 7 is a simplified diagram of a keyboard illustrating a detected location for a two-touch multiple touch detection in accordance with an embodiment of the present invention.

FIG. 8 is a simplified diagram of a keyboard illustrating a detected location for a three-touch multiple touch detection in accordance with an embodiment of the present invention.

FIG. 9 is a simplified block diagram illustrating an input device in accordance with an embodiment of the present invention.

FIG. 10 is a simplified block diagram illustrating an input device in accordance with another embodiment of the present invention.

### DETAILED DESCRIPTION OF THE PREFERRED EMBODIMENT

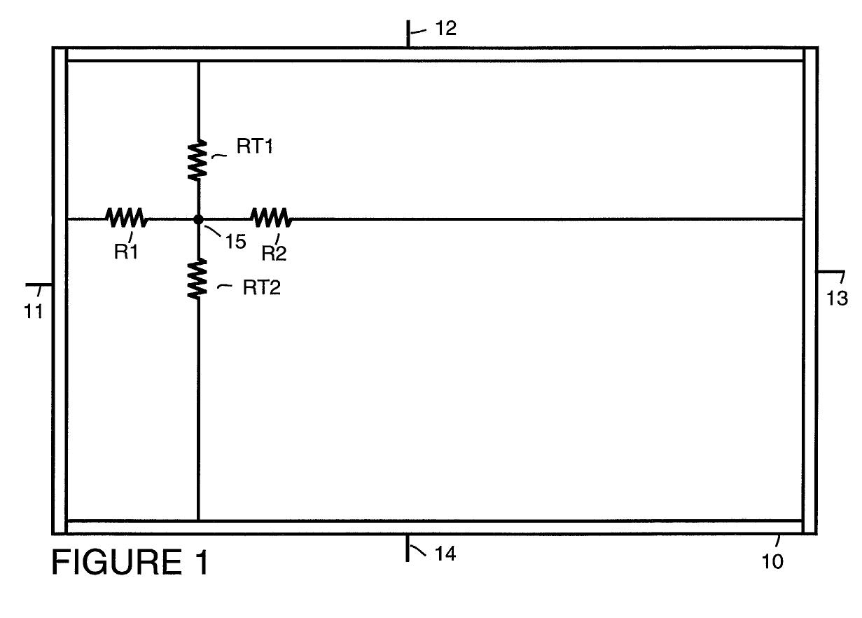

FIG. 1 shows a schematic of an input device 10. Input device 10 is, for example, a touchpad, a touchscreen or some other device capable of detecting touch. Input device 10 consists of two sheets of conductive coated material layered on top of each other with conductive sides facing each other. For example, the conductive layers are constructed with Indium Tin Oxide (ITO) in a thin layer such that it can be transparent and used over LCD screens. Alternatively, for example when transparent characteristics are not needed, carbon or some other conductive material is coated on a Mylar type substrate. Spacing between the conductive layers is accomplished, for example, with small spacers in the form of glass beads that hold the conductive layers apart.

In FIG. 1 a conductor 11 and a conductor 13 are connected to a first conductive layer. A conductor 12 and a conductor 14 are connected to a second conductive layer. The conductive layers are alternatively biased. Each conductive layer is temporarily biased to generate a voltage gradient between the two conductors connected to the conductive layer. The voltage gradient is present because the conductive layer provides sufficient impedance between the conductors to produce a measurable voltage gradient. The impedance per distance between the two conductors is constant throughout each conductive layer. Thus each conductive layer, when biased, acts as a resistive pad.

When one conductive layer is biased, the other conductive layer is at a high impedance state. This allows the conductors of the unbiased conductive layer to record a voltage value at a point of contact with minimal voltage drop due to low current flow. From this voltage value, one dimension of the point of contact can be determined.

For example, in FIG. 1, at a point of contact 15, a touch on input device 10 has produced a contact between the two conductive layers. When the first conductive layer is biased, for example by placing a voltage V1 on conductor 11 and −V1 on conductor 13, a voltage gradient exists across the first conductive layer. The voltage value on conductor 12 and conductor 14 is allowed to “float” in a high impedance state. R1 represents the resistance provided by the first conductive layer from conductor 11 to point of contact 15. R2 represents the resistance provided by the first conductive layer from conductor 13 to point of contact 15. RT1 represents impedance in the second conductive layer from point of contact 15 to conductor 12. RT2 represents impedance from point of contact 15 to conductor 14. Since conductor 12 and conductor 14 are in a high impedance state, RT1 and RT2 draw so little current that the voltage level of the entire second conductive layer “floats” at the voltage level of the first conductive layer at point of contact 15. A detector converts the voltage value detected at conductor 12 and/or 14 to a position (P1) based on Equation 1 below:

P1=C1*(R2/(R1+R2)) Equation 1

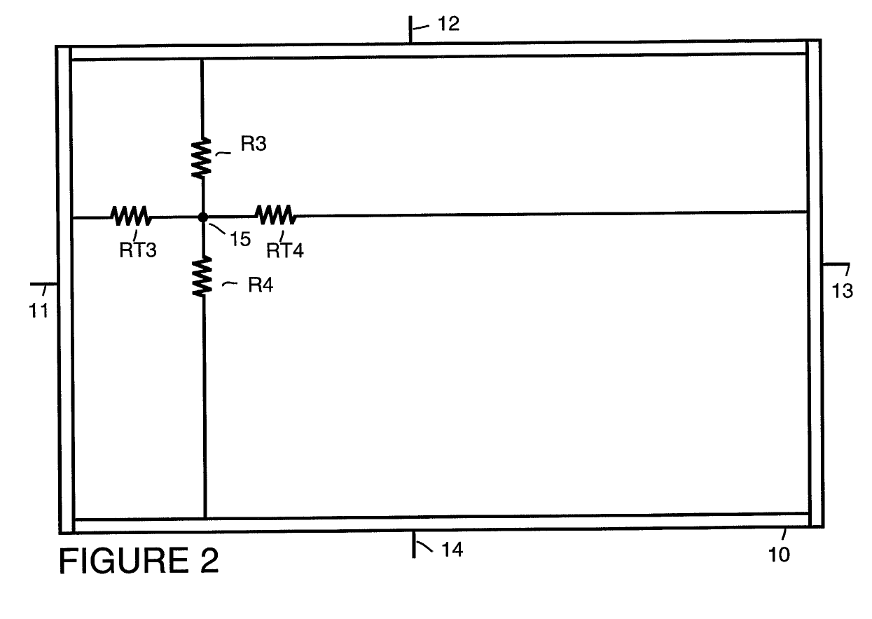

In equation 1, C1 is a constant that represents a maximum value for position (P1). Likewise, as illustrated by FIG. 2, when the second conductive layer is biased, for example by placing a voltage V2 on conductor 12 and −V2 on conductor 14, a voltage gradient exists across the second conductive layer. The voltage value on conductor 11 and conductor 13 is allowed to “float” in a high impedance state. R3 represents the resistance provided by the second conductive layer from conductor 12 to point of contact 15. R4 represents the resistance provided by the second conductive layer from conductor 14 to point of contact 15. RT3 represents impedance in the first conductive layer from point of contact 15 to conductor 11. RT4 represents impedance from point of contact 15 to conductor 13. Since conductor 11 and conductor 13 are in a high impedance state, RT3 and RT4 draw so little current that the voltage level of the entire first conductive layer “floats” at the voltage level of the second conductive layer at point of contact 15. The detector converts the voltage value detected at conductor 12 and/or 14 to a position (P2) based on Equation 2 below:

P2=C2*(R4/(R3+R4)) Equation 2

In equation 2, C2 is a constant that represents a maximum value for position (P2).

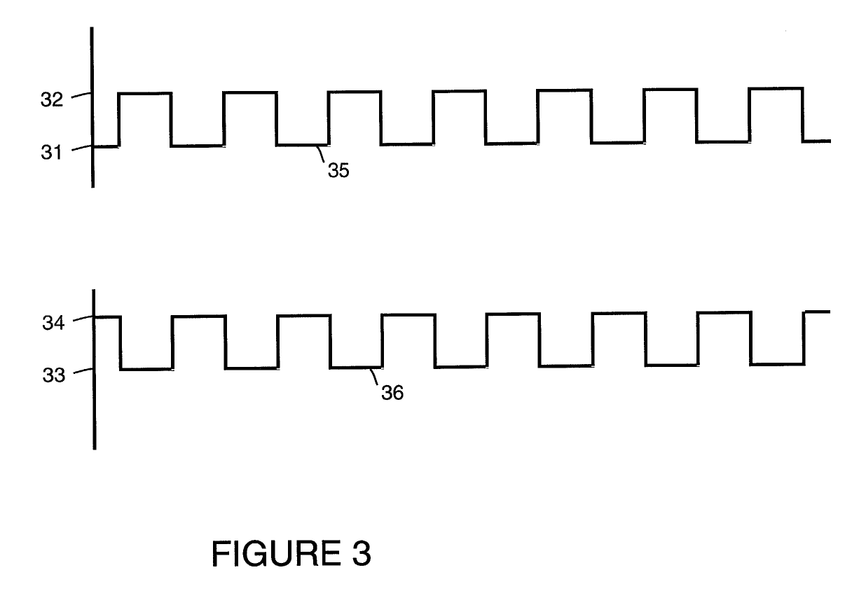

The layers are alternatively biased or strobed. This is illustrated by FIG. 3. In FIG. 3, a waveform 35 represents biasing of conductor 11 and conductor 13. When waveform 35 is in a state 31, this represents conductor 11 and conductor 13 being in a high impedance state in which the detector detects the voltage level on conductor 11 and/or conductor 13 to determine a voltage at a contact point. When waveform 35 is in a state 32, this represents voltage V1 being placed on conductor 11 and voltage −V1 being placed on conductor 13.

A waveform 36 represents biasing of conductor 12 and conductor 14. When waveform 36 is in a state 33, this represents conductor 12 and conductor 14 being in a high impedance state in which the detector detects the voltage level on conductor 12 and/or conductor 14 to determine a voltage at a contact point. When waveform 36 is in a state 34, this represents voltage V2 being placed on conductor 12 and voltage −V2 being placed on conductor 14.

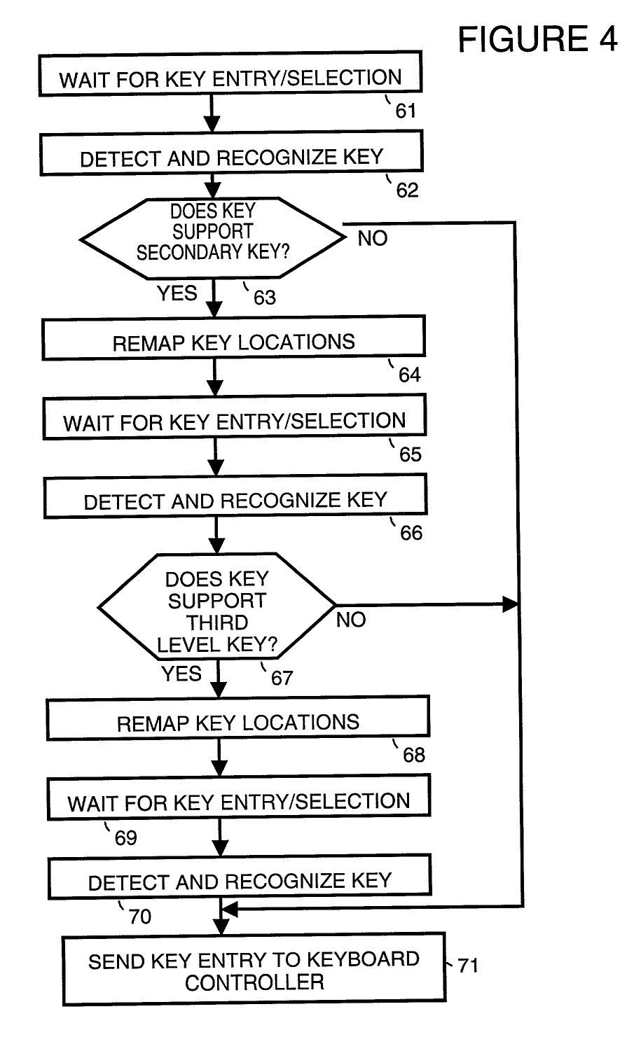

FIG. 4 is a simplified flowchart describing multiple touch key detection for input device 10. Herein, the meaning of key includes any area or region on a touch activated device, selection of which conveys particular input information. The input information can include, for example, a letter, a number, a special character, a command or any other type of information that can be input to any system having computing capability.

In a step 61, the process waits for a key entry or selection. In a step 62, the key is detected and recognized. This is done, for example, using Equation 1 and Equation 2 above. A full cycle includes obtaining values in both horizontal and vertical dimensions. In a step 63, a determination is made as to whether the recognized key supports a secondary key. If not, in a step 71, the key entry is sent to the keyboard controller and the process is complete.

If in step 63, the determination is made that the recognized key supports a secondary key, in a step 64 key locations are remapped. This is done prior to accepting the next input. The remapping takes into account the voltage that will now show up from the touch input to match up what the user intends the input to be.

The remapping is performed, for example, by changing the table used to lookup the voltage output from the keyboard. For example, for every key that supports a secondary key, a look-up table exists that gives remapped values for each potential secondary key. For example, each entry in the look-up table includes a particular voltage or voltage range that indicates selection of a key.

Values for the look-up table can be obtained, for example, at the factory through voltage measurements. Alternatively, a single look-up table can be used and different formulas applied to allow remapping of selected secondary keys. Selection of the formulas is based on the identity of the initially selected (i.e., primary) key that supports a secondary key. Each entry in the table is, for example, a particular voltage or a range of voltages that indicates selection of a particular key.

In addition to remapping selected secondary keys, in some embodiments of the invention, for example when a liquid crystal display (LCD) touchscreen is used for a keyboard, the keyboard display highlights the new valid keys or options to the user after the primary key is selected. Alternatively, after a primary is selected, the keyboard display shows only the valid keys or options to the user. Alternatively, or in addition, the potential secondary keys can be relabeled, for example, in accordance with an assigned function. For example, if the combination of “FN” as the primary key and “C” as the secondary key is a shortcut for the “copy” command, upon selection of the “FN” key as a primary key, the “C” key on the keyboard display can be relabeled to indicate “copy”. Alternatively, if the combination of “FN” as the primary key and “C” as the secondary key is a shortcut for the “copy” command, upon selection of the “FN” key as a primary key, a label such as “c=copy” could appear elsewhere on the display along with other translations such as “x=cut” and “v=paste”. For example, the relabeling described above can be personalized by each user. The relabeling is done at the original key locations and not at the remapped key locations. As discussed above, the remapping is done when detecting location of touch and does not affect the physical location of keys.

In a step 65, the process waits for a key entry or selection. In a step 66, the key is detected and recognized. Key entry or selection is detected by detection of a voltage change that occurs without an intermittent period in which no key is selected. The result is a delta in voltage (after debouncing) that can be used to recognize an additional point of contact.

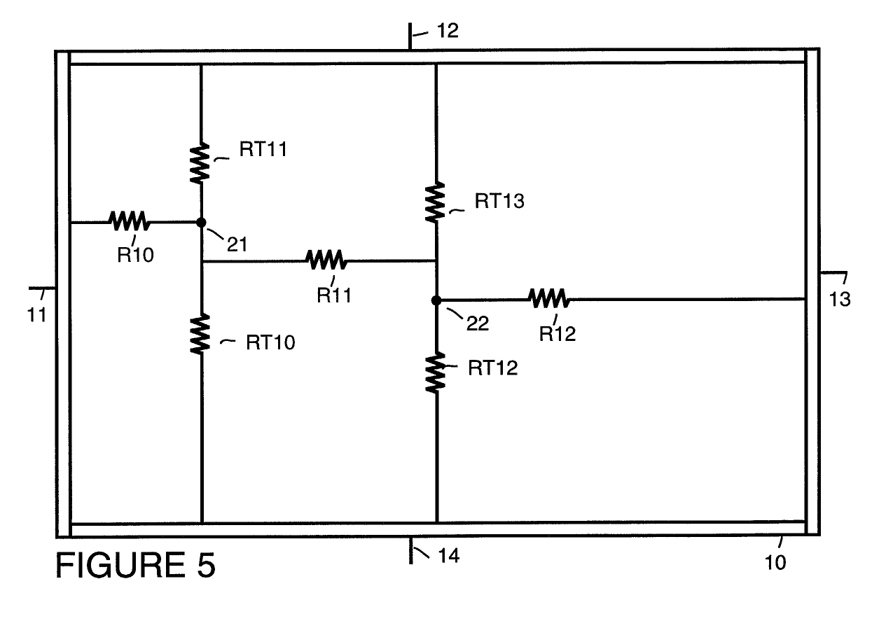

For example, in FIG. 5, at a point of contact 21, a touch on input device 10 has produced a contact between the two conductive layers. Also, at a point of contact 22, a second touch on input device 10 has produced a second contact between the two conductive layers. When the first conductive layer is biased, for example by placing a voltage V1 on conductor 11 and −V1 on conductor 13, a voltage gradient exists across the first conductive layer. The voltage value on conductor 12 and conductor 14 is allowed to “float” in a high impedance state. R10 represents the resistance provided by the first conductive layer from conductor 11 to point of contact 21. R12 represents the resistance provided by the first conductive layer from conductor 13 to point of contact 22. R11 represents the resistance provided by the first conductive layer from point of contact 21 to point of contact 22. RT11 represents impedance in the second conductive layer from point of contact 21 to conductor 12. RT10 represents impedance from point of contact 21 to conductor 14. RT13 represents impedance in the second conductive layer from point of contact 22 to conductor 12. RT12 represents impedance from point of contact 22 to conductor 14. The detector converts the voltage value detected at conductor 12 and/or 14 to a position (AP1) that can be approximated by Equation 3 below:

AP1=C1*(R12+(R11/2))/(R10+R11+R12) Equation 3

In equation 3, C1 is the constant that represents a maximum value for position (P1) and (AP1).

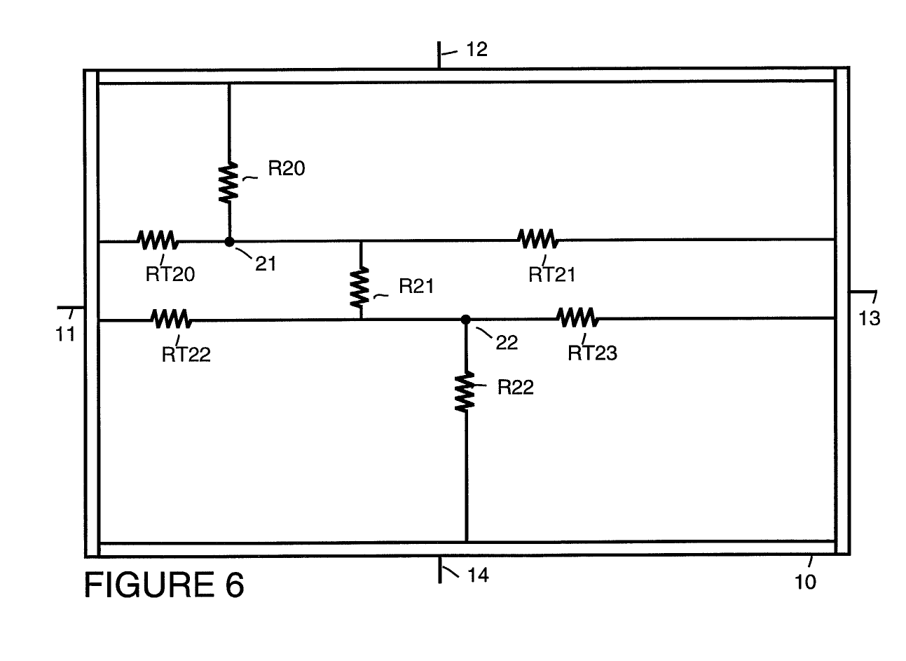

Likewise, in FIG. 6, when the second conductive layer is biased, for example by placing a voltage V2 on conductor 12 and −V2 on conductor 14, a voltage gradient exists across the second conductive layer. The voltage value on conductor 11 and conductor 13 is allowed to “float” in a high impedance state. R20 represents the resistance provided by the first conductive layer from conductor 12 to point of contact 21. R22 represents the resistance provided by the first conductive layer from conductor 14 to point of contact 22. R21 represents the resistance provided by the first conductive layer from point of contact 21 to point of contact 22. RT20 represents impedance in the second conductive layer from point of contact 21 to conductor 11. RT21 represents impedance from point of contact 21 to conductor 13. RT22 represents impedance in the second conductive layer from point of contact 22 to conductor 11. RT23 represents impedance from point of contact 22 to conductor 13. The detector converts the voltage value detected at conductor 11 and/or 13 to a position (AP2) that can be approximated by Equation 4 below:

AP2=C2*(R22+(R21/2))/(R20+R21+R22) Equation 4

In equation 4, C2 is the constant that represents a maximum value for position (P2) and (AP2).

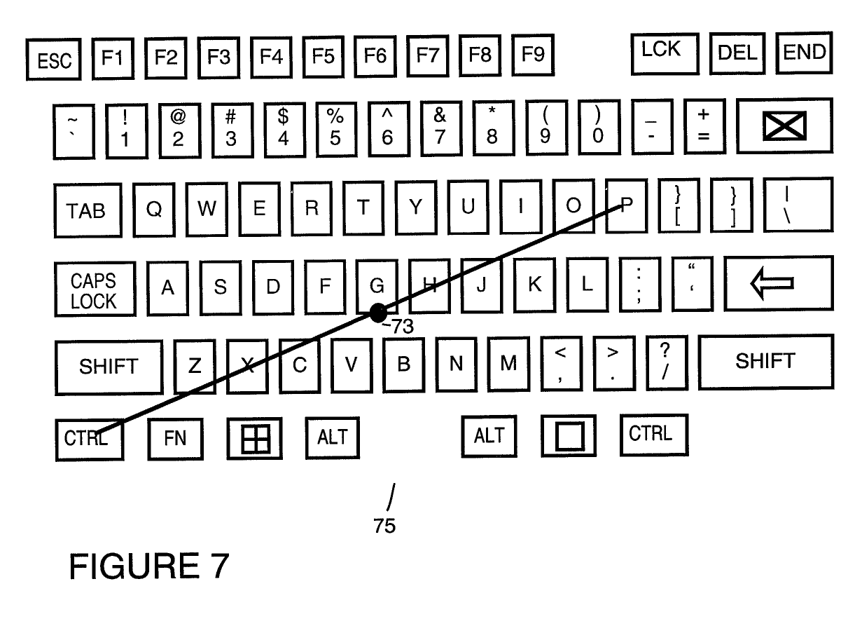

For example, FIG. 7 shows a location 73 on a displayed keyboard 75. Location 73 is the remapped position for the “P” key after the “CTRL” key is selected. Thus, after the “CTRL” key has been detected in step 62 (shown in FIG. 4) and the location (AP1, AP2) mapping to position 73 is detected in step 66, the “P” key is recognized. As can be seen by FIG. 7, the position 73 is between the “CTRL” key and the “P” key.

In a step 67, a determination is made as to whether the recognized key supports a tertiary level key. If not, in step 71, the key entry is sent to the keyboard controller and the process is complete.

If in step 67, the determination is made that the recognized key supports a tertiary key, in a step 68 key locations are again remapped. This is done prior to accepting the next input. The remapping matches the touch input to what the user intends the input to be.

The remapping is performed, for example, by changing the table used to lookup the voltage output from the keyboard. For example, for every combination of primary key and secondary key that supports a tertiary key, a look-up table exists that gives remapped values for each potential tertiary key. For example, each entry in the look-up table includes a particular voltage or voltage range that indicates selection of a key. Values for the look-up table can be determined, for example, at the factory through voltage measurements. Alternatively, a single look-up table can be used and different formulas applied to allow remapping of selected tertiary keys. Selection of the formulas is based on the identity of the primary and secondary key.

As discussed above, in addition to remapping selected tertiary keys, in some embodiments of the invention, the keyboard display highlights the new valid keys or options to the user. The potential secondary keys can be relabeled, for example, in accordance with an assigned function. For example, the relabeling described above can be personalized by each user.

In a step 69, the process waits for a key entry or selection. In a step 70, the key is detected and recognized. In step 71, the key entry is sent to the keyboard controller and the process is complete.

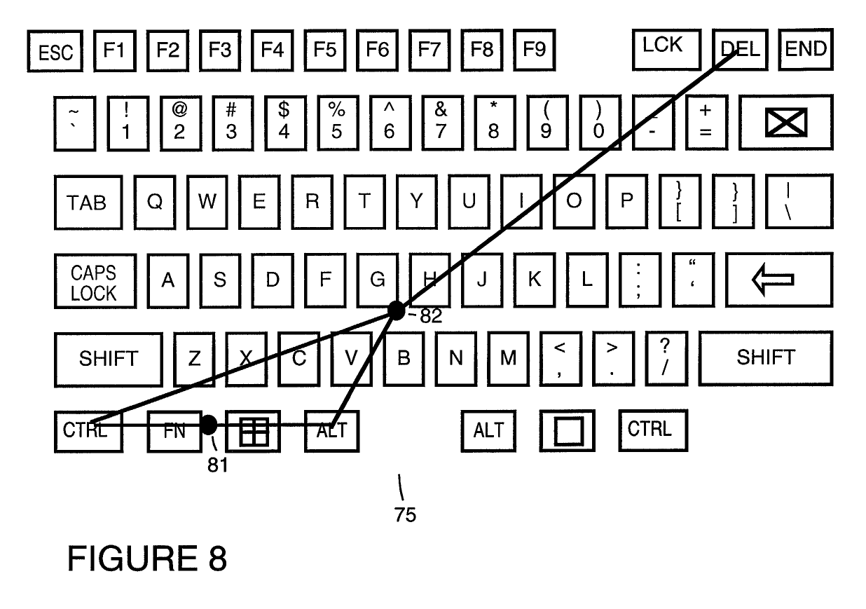

For example, FIG. 8 shows a location 82 on displayed keyboard 75. Location 82 is the remapped position for the “DEL” key after both the “CTRL” key and the “ALT” key are selected. Thus, after the “CTRL” key has been detected in step 62 (shown in FIG. 4) and the “ALT” key is detected in step 66, when a location mapping to position 82 is detected in step 70, the “DEL” key is recognized. As can be seen by FIG. 8, the position 82 is between the position of the “DEL” key, the “CTRL” key and the “ALT” key.

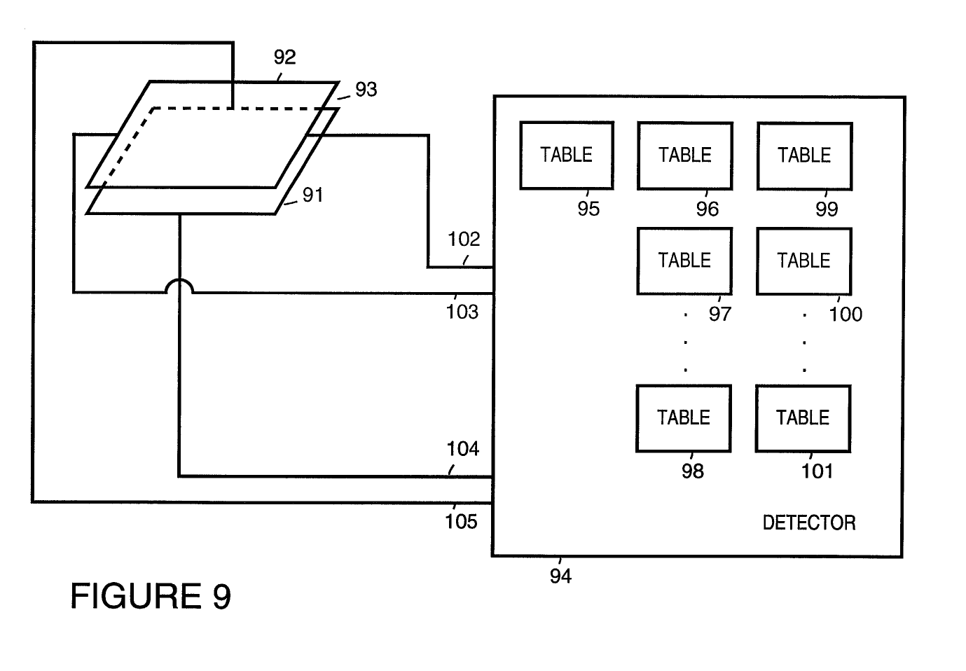

FIG. 9 shows a block diagram of an input device that implements multiple touch key detection. A resistive pad 91 is separated from a resistive pad 92 by an insulating space 93. A conductor 102 and a conductor 103 connect resistive pad 92 to a detector 94. A conductor 104 and a conductor 105 connect resistive pad 91 to detector 94. Detector 94 places a first known voltage across conductive pad 91 using conductors 104 and 105 and while detecting voltages on conductors 102 and 103. Detector 94 also places a second known voltage across conductive pad 92 using conductors 102 and 103 and while detecting voltages on conductors 104 and 105. The first known voltage and the second known voltage can be equal or different, depending upon the specific implementation of the invention.

When only a single key is pressed, the resulting voltage pair is mapped into a key using table 95. When a primary key is pressed and held and a secondary key is pressed, the resulting voltage pair is mapped to the secondary key using one of the secondary tables, represented in FIG. 9 by a table 96, a table 97 and a table 98. For each primary key that allows selection of a secondary key, one of the secondary tables is used to map voltage pairs to potential secondary keys for that primary key.

When both a primary key and secondary key are pressed and held and a tertiary key is pressed, the resulting voltage pair is mapped to the tertiary key using one of the tertiary tables, represented in FIG. 9 by a table 99, a table 100 and a table 101. For each combination of primary key and secondary key that allows selection of a tertiary key, one of the tertiary tables is used to map voltage pairs to potential tertiary keys for that combination of primary key and secondary key.

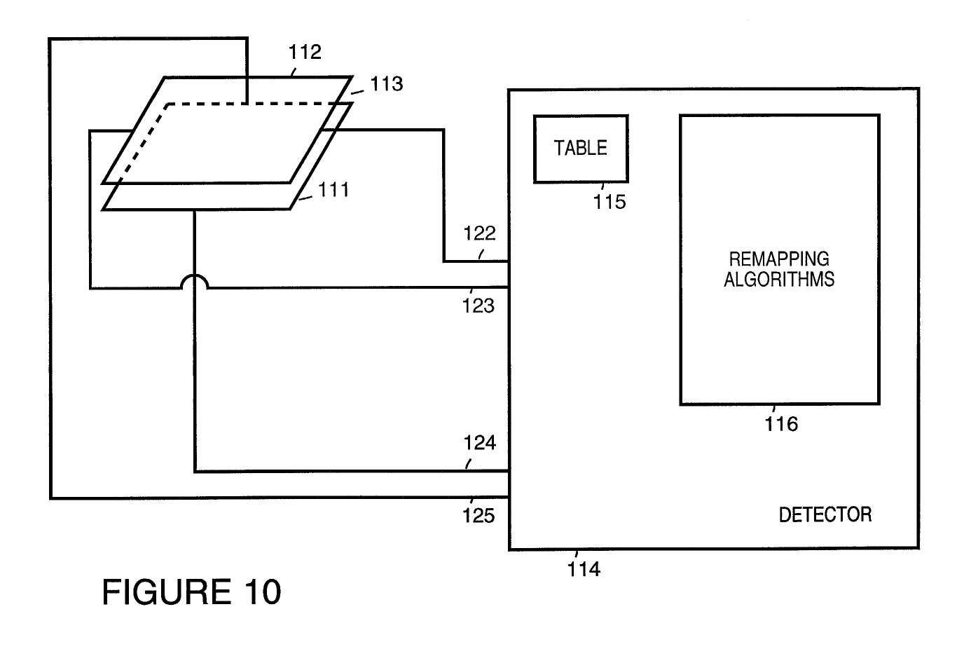

FIG. 10 shows a block diagram of an input device that implements multiple touch key detection using only a single table. A resistive pad 111 is separated from a resistive pad 112 by an insulating space 113. A conductor 122 and a conductor 123 connect resistive pad 112 to a detector 114. A conductor 124 and a conductor 125 connect resistive pad 111 to detector 114. Detector 114 places a first known voltage across conductive pad 111 using conductors 124 and 125 and while detecting voltages on conductors 122 and 123. Detector 114 also places a second known voltage across conductive pad 112 using conductors 122 and 123 and while detecting voltages on conductors 124 and 125.

When only a single key is pressed, the resulting voltage pair is mapped into a key using table 115. When a primary key is pressed and held and a secondary key is pressed, the resulting voltage pair is mapped to the secondary key using remapping algorithms 116 and table 115. For each primary key that allows selection of a secondary key, one or more algorithms are used to adjust values in table 115.

When both a primary key and secondary key are pressed and held and a tertiary key is pressed, the resulting voltage pair is mapped to the tertiary key using remapping algorithms 116 and table 115. For each combination of primary key and secondary key that allows selection of a tertiary key, one or more algorithms are used to adjust values in table 115.

The foregoing discussion discloses and describes merely exemplary methods and embodiments of the present invention. As will be understood by those familiar with the art, the invention may be embodied in other specific forms without departing from the spirit or essential characteristics thereof.

For example, the present invention has been explained using an embodiment in which an input device is constructed using two sheets of resistive pads. However, the invention can also be applied to input devices implemented using other technologies to detect selection of keys, areas or regions. The other technologies include, for example, optical, acoustic or capacitive based input devices. Accordingly, the disclosure of the present invention is intended to be illustrative, but not limiting, of the scope of the invention, which is set forth in the following claims.

What is claimed is:

1. An input device that allows multiple touch key entry comprising:
a plurality of keys; and,
a detector that detects selection of keys;
wherein the detector identifies a first selected key by detecting a first detected value and using a first mapping of detected values to keys to map the first detected value to the first selected key; and,
wherein the detector identifies a second selected key by detecting a second detected value, and using a second mapping of detected voltages to keys to map the second value to the second selected key, wherein the first mapping of detected values to keys is different than the second mapping of detected values to keys.

2. An input device as in claim 1 wherein the detector identifies a third selected key by detecting a third detected value, and using a third mapping of detected voltages to keys to map the third value to the third selected key, wherein the third mapping of detected values to keys is different than the second mapping of detected values to keys and is different than the first mapping of detected values to keys.

3. An input device as in claim 1:
wherein the first mapping maps detected values to keys when a single key is selected; and,
wherein the second mapping maps detected values to keys when, after selecting and holding the first key, another key is selected.

4. An input device as in claim 1:
wherein the first mapping maps detected values to keys when a single key is selected;
wherein the second mapping maps detected values to keys when, after selecting and holding the first key, another key is selected; and,
wherein a third mapping maps detected values to keys when, after selecting and holding a third key, another key is selected.

5. An input device as in claim 1:
wherein the first mapping maps detected values to keys when a single key is selected, the first mapping being accomplished using a first table; and,
wherein the second mapping maps detected values to keys when, after selecting and holding the first key, another key is selected, the second mapping being accomplished using a second table.

6. An input device as in claim 1:
wherein the first mapping maps detected values to keys when a single key is selected, the first mapping being accomplished using a table; and,
wherein the second mapping maps detected values to keys when, after selecting and holding the first key, another key is selected, the second mapping being accomplished using calculations to adjust values in the table.

7. An input device that allows multiple touch key entry comprising:
a first resistive pad;
a second resistive pad, wherein the first resistive pad is separated from the second resistive pad by an insulating space, the first resistive pad being pressed into contact with the second resistive pad at a location where a user touches the input device; and,
a detector;
wherein the detector identifies a first selected key by placing a first known voltage across the first resistive pad and detecting a first detected voltage on the second resistive pad, placing a second known voltage across the second resistive pad and detecting a second detected voltage on the first resistive pad, and using a first mapping of detected voltages to keys to map the first detected voltage and the second detected voltage to the first selected key; and,
wherein the detector identifies a second selected key which is selected while the first selected key remains selected by placing the first known voltage across the first resistive pad and detecting a third detected voltage on the second resistive pad, placing the second known voltage across the second resistive pad and detecting a fourth detected voltage on the first resistive pad, and using a second mapping of detected voltages to keys to map the third detected voltage and the fourth detected voltage to the second selected key.

8. An input device as in claim 7 wherein the detector identifies a third selected key which is selected while the first selected key and the second selected key remain selected by placing the first known voltage across the first resistive pad and detecting a fifth detected voltage on the second resistive pad, placing the second known voltage across the second resistive pad and detecting a sixth detected voltage on the first resistive pad, and using a third mapping of detected voltages to keys to map the fifth detected voltage and the sixth detected voltage to the third selected key.

9. An input device as in claim 7 wherein the first known voltage is equal to the second known voltage.

10. An input device as in claim 7:
wherein the first mapping maps voltage pairs to keys when a single key is selected; and,
wherein the second mapping maps voltage pairs to keys when, after selecting and holding the first key, another key is selected.

11. An input device as in claim 7:
wherein the first mapping maps voltage pairs to keys when a single key is selected;
wherein the second mapping maps voltage pairs to keys when, after selecting and holding the first key, another key is selected; and,
wherein a third mapping maps voltage pairs to keys when, after selecting and holding a third key, another key is selected.

12. An input device as in claim 7:
wherein the first mapping maps voltage pairs to keys when a single key is selected, the first mapping being accomplished using a first table; and,
wherein the second mapping maps voltage pairs to keys when, after selecting and holding the first key, another key is selected, the second mapping being accomplished using a second table.

13. An input device as in claim 7:
wherein the first mapping maps voltage pairs to keys when a single key is selected, the first mapping being accomplished using a table; and,
wherein the second mapping maps voltage pairs to keys when, after selecting and holding the first key, another key is selected, the second mapping being accomplished using calculations to adjust values in the table.

14. An input device as in claim 7 wherein the first resistive pad and the second resistive pad are part of a touch pad.

15. An input device as in claim 7 wherein the first resistive pad and the second resistive pad are part of a touch screen.

16. A computing system, the computing system comprising:
an input system that allows multiple touch key entry, the input system comprising:
a first resistive pad,
a second resistive pad, wherein the first resistive pad is separated from the second resistive pad by an insulating space, the first resistive pad being selected into contact with the second resistive pad at a location where a user touches the keyboard, and
a detector;
wherein the detector identifies a first selected key by placing a first known voltage across the first resistive pad and detecting a first detected voltage on the second resistive pad, placing a second known voltage across the second resistive pad and detecting a second detected voltage on the first resistive pad, and using a first mapping of detected voltages to keys to map the first detected voltage and the second detected voltage to the first selected key; and,
wherein the detector identifies a second selected key which is selected while the first selected key remains selected by placing the first known voltage across the first resistive pad and detecting a third detected voltage on the second resistive pad, placing the second known voltage across the second resistive pad and detecting a fourth detected voltage on the first resistive pad, and using a second mapping of detected voltages to keys to map the third detected voltage and the fourth detected voltage to the second selected key.

17. A computing system as in claim 16 wherein the detector identifies a third selected key which is selected while the first selected key and the second selected key remain selected by placing the first known voltage across the first resistive pad and detecting a fifth detected voltage on the second resistive pad, placing the second known voltage across the second resistive pad and detecting a sixth detected voltage on the first resistive pad, and using a third mapping of detected voltages to keys to map the fifth detected voltage and the sixth detected voltage to the third selected key.

18. A computing system as in claim 16:
wherein the first mapping maps voltage pairs to keys when a single key is selected; and,
wherein the second mapping maps voltage pairs to keys when, after selecting and holding the first key, another key is selected.

19. A computing system as in claim 16:
wherein the first mapping maps voltage pairs to keys when a single key is selected;
wherein the second mapping maps voltage pairs to keys when, after selecting and holding the first key, another key is selected; and,
wherein a third mapping maps voltage pairs to keys when, after selecting and holding a third key, another key is selected.

20. A computing system as in claim 16 wherein the input device is a touch pad.

21. A computing system as in claim 16 wherein the input device is a touch screen.

22. An input device that allows multiple touch key entry comprising:
a first resistive pad means for providing a first resistance between two ends of the first resistive pad means;
a second resistive pad means for providing a second resistance between two ends of the second resistive pad means;
a separation means for separating the first resistive pad means from the second resistive pad means, wherein the first resistive pad means is pressed into contact with the second resistive pad means at a location where a user touches the input device; and,
a detecting means for identifying a first selected key by placing a first known voltage across the two ends of first resistive pad means and detecting a first detected voltage on the second resistive pad means, placing a second known voltage across the two ends of the second resistive pad means and detecting a second detected voltage on the first resistive pad means, and using a first mapping of detected voltages to keys to map the first detected voltage and the second detected voltage to the first selected key;
wherein the detecting means identifies a second selected key which is selected while the first selected key remains selected by placing the first known voltage across the first resistive pad means and detecting a third detected voltage on the second resistive pad means, placing the second known voltage across the second resistive pad means and detecting a fourth detected voltage on the first resistive pad means, and using a second mapping of detected voltages to keys to map the third detected voltage and the fourth detected voltage to the second selected key.

23. An input device as in claim 22 wherein the detecting means identifies a third selected key which is selected while the first selected key and the second selected key remain selected by placing the first known voltage across the first resistive pad means and detecting a fifth detected voltage on the second resistive pad means, placing the second known voltage across the second resistive pad means and detecting a sixth detected voltage on the first resistive pad means, and using a third mapping of detected voltages to keys to map the fifth detected voltage and the sixth detected voltage to the third selected key.

24. An input device as in claim 22:
wherein the first mapping maps voltage pairs to keys when a single key is selected; and,
wherein the second mapping maps voltage pairs to keys when, after selecting and holding the first key, another key is selected.

25. An input device as in claim 22:
wherein the first mapping maps voltage pairs to keys when a single key is selected;
wherein the second mapping maps voltage pairs to keys when, after selecting and holding the first key, another key is selected; and,
wherein a third mapping maps voltage pairs to keys when, after selecting and holding a third key, another key is selected.

26. A method for recognizing multiple touch entries on an input device, the method comprising the following steps:
(a) upon a user selecting a first key, recognizing the first key based on first detected values, the first detected values being mapped to the first key based on a first mapping of values to keys;
(b) when the first key supports at least one secondary key, performing the following substep:
(b.1) upon a user selecting a second key while continuing to select the first key, recognizing the second key based on second detected values, the second detected values being mapped to the second key based on a second mapping of values to keys, the second mapping of values to keys being different than the first mapping of values to keys.

27. A method as in claim 26 where step (b) additionally comprises the following substep:
(b.2) when a combination of the first key and the second key supports at least one tertiary key, performing the following substep:
upon a user selecting a third key while continuing to select the first key and the second key, recognizing the third key based on third detected values, the third detected values being mapped to the third key based on a third mapping of values to keys, the third mapping of values to keys being different than the first mapping of values to keys and being different than the second mapping of values to keys.

28. A method as in claim 26 wherein step (b) includes the following substep performed before substep (b.1):
highlighting keys that are supported as secondary keys for the first key.

29. A method as in claim 28 where step (b) additionally comprises the following sub step:
(b.2) when a combination of the first key and the second key supports at least one tertiary key, performing the following substeps:
highlighting keys that are supported as tertiary keys for the combination of the first key and the second key; and,
upon a user selecting a third key while continuing to select the first key and the second key, recognizing the third key based on third detected values, the third detected values being mapped to the third key based on a third mapping of values to keys, the third mapping of values to keys being different than the first mapping of values to keys and being different than the second mapping of values to keys.

30. A method as in claim 28 wherein step (b) includes the following substep performed before substep (b.1):
displaying only keys that are supported as secondary keys for the first key.

31. A method as in claim 30 where step (b) additionally comprises the following sub step:
(b.2) when a combination of the first key and the second key supports at least one tertiary key, performing the following substeps:
displaying only keys that are supported as tertiary keys for the combination of the first key and the second key; and,
upon a user selecting a third key while continuing to select the first key and the second key, recognizing the third key based on third detected values, the third detected values being mapped to the third key based on a third mapping of values to keys, the third mapping of values to keys being different than the first mapping of values to keys and being different than the second mapping of values to keys.
